(19) United States
(12) Patent Application Publication
(10) Pub. No.: US 2008/0028770 A1
(43) Pub. Date: Feb. 7, 2008

(54) Method and device for cryocondensation

(76) Inventor: Heinz-Dieter Obermeyer, Freising (DE)

Correspondence Address: THE BOC GROUP, INC., 575 MOUNTAIN AVENUE, MURRAY HILL, NJ, 07974-2064, US

(21) Appl. No.: 11/879,963

(22) Filed: Jul. 19, 2007

(30) Foreign Application Priority Data
Aug. 4, 2006 (DE) 102006036610.7

(51) Int. Cl. B01D 8/00

(52) U.S. Cl. 62/55.5

(57) ABSTRACT

The invention relates to a method and a device for the cleaning of a process gas (1) through cryocondensation in a cryogenic cooler (TK). According to the invention the process gas is precooled in a condensate precooler (KVK) in indirect heat exchange with the condensate (5) separated from the process gas (1, 2, 3) in the cryogenic cooler (TK) before it is directed into the cryogenic cooler (TK).

Method for the cooling and/or cleaning of a process gas, wherein the process gas is cooled and partially condensed in a cryogenic cooler in indirect heat exchange with a refrigerant flow of nitrogen, wherein the contaminations accumulate as condensate and are separated from the process gas flow. In addition, the invention relates to a device for the cooling and/or cleaning of a process gas comprising a cryogenic cooler embodied as indirect heat exchanger with a process gas feed and a process gas discharge, with a refrigerant feed and a refrigerant discharge and with a condensate drain.

During the cleaning of a process gas by means of cryocondensation the process gas to be cleaned is subjected to indirect heat exchange with a cryogenic refrigerant in a heat exchanger in order to freeze out or condensate out contaminations from the process gas to obtain said process gas as clean gas. Liquid nitrogen is frequently employed as refrigerant.

In the heat exchanger the process gas is cooled down so far that the undesirable constituent parts condensate out as liquid. This condensate can then be drained via a condensate drain which is customarily arranged at the deepest point of the passage for the process gas leading through the heat exchanger.

To reduce the nitrogen consumption with the existing plants for cryocondensation, the cold gaseous nitrogen which develops during the heat exchange between the liquid nitrogen and the process gas and the cold clean gas are employed for precooling the process gas to be cleaned. Thus, a cryocondensation plant can consist of several heat exchangers through which the process gas passes in series.

For example the cooling-down of the process gas flow takes place successively in a clean gas precooler, a precooler and a cryogenic cooler all of which are embodied as indirect heat exchangers. The cryogenic cooler being charged with liquid nitrogen as refrigerant. The drained evaporated nitrogen from the cryogenic cooler is subsequently used as refrigerant in the precooler. In the clean gas cooler the clean gas drained from the cryogenic cooler is employed for cooling the process gas flow.

The object of the present invention is to further lower the consumption of refrigerant with a method of the type mentioned at the outset. In addition, a corresponding device is to be developed.

This object is solved through a method for cooling and/or cleaning of a process gas wherein the process gas is cooled and partially condensed in a cryogenic cooler in indirect heat exchange with a refrigerant flow of nitrogen, wherein the developing condensate is separated from the process gas flow and wherein the process gas prior to being directed into the cryogenic cooler is precooled in a condensate precooler in indirect heat exchange with the condensate.

The device for the cooling and/or cleaning of a process gas according to the invention comprises a cryogenic cooler embodied as indirect heat exchanger with a process gas feed and a process gas discharge, with a refrigerant feed and a refrigerant discharge, and with a condensate drain and is characterized in that a condensate precooler embodied as indirect heat exchanger with a process gas feed and a process gas discharge and with a refrigerant feed and a refrigerant discharge is provided, wherein both the process gas discharge of the condensate precooler and the process gas feed of the cryogenic cooler and the condensate drain of the cryogenic cooler and the refrigerant feed of the condensate precooler are connected on the flow side.

The substantial part of the invention is the introduction of one or several additional heat exchangers in the cryocondensation plant. In the past, the developing condensate was disposed of in liquid form or supplied for reclamation.

The idea now is to employ the cold condensate obtained for precooling the process gas in a heat exchanger. Precooling can be performed with one or several heat exchangers. The condensate is evaporated during this heat exchange and is obtained as gaseous product for disposal or reclamation.

In the cryogenic cooler, preferentially cryogenic nitrogen, particularly preferably in liquid form, is employed as refrigerant.

To save refrigerant the process gas is advantageously precooled in a precooler at first. The refrigerant exiting from the cryogenic cooler still possesses a sufficiently low temperature to bring about precooling of the process gas flow. The refrigerant drained from the cryogenic cooler is thus supplied to a precooler through which, preferentially in counterflow, the process gas is passed and precooled before it is directed into the cryogenic cooler.

To this end, the precooler is embodied with a process gas feed, a process gas discharge, a refrigerant feed and a refrigerant discharge, wherein the process gas discharge of the precooler is connected on the flow side with the process gas feed of the cryogenic cooler and the refrigerant discharge of the cryogenic cooler is connected on the flow side with the refrigerant feed of the precooler.

The term “connected on the flow side” must be understood such that a fluid is able to flow from one line to the other line or from one vessel to another vessel. To this end, a direct connection between the two lines is not absolutely imperative. Indeed it is also the object of the invention to provide additional components between the two lines or vessels connected on the flow side as long as the fluid is able to flow through these components. More preferably a further heat exchanger or vessel can be connected between a first and a second line which are connected to one another on the flow side, through which the fluid flows having left the first line before entering the second line.

The precooler, just as the cryogenic cooler, are embodied as indirect heat exchangers, i.e. the respective refrigerant flow and the process gas flow to be cooled are conducted in separate passages so that no mixing occurs between these flows. The refrigerant flow can thus be further used for other purposes, for example as inertisation medium. Conversely, the process gas flow is not contaminated through the refrigerant.

In a preferred embodiment of the invention the process gas flow flows first through the condensate precooler and then the precooler in order to finally be entirely cooled down to the desired temperature in the cryogenic cooler.

Further refrigerant saving is preferably achieved in that the cleaned process gas drained from the cryogenic cooler, hereinafter referred to as clean gas, is also utilised for precooling of the unpurified process gas. In the cryogenic cooler the process gas is cooled with liquid nitrogen for example. Thus, the clean gas leaves the cryogenic cooler with a correspondingly low temperature. This cold clean gas is now brought in heat exchange contact with the process gas flow in a clean gas precooler likewise embodied as indirect heat exchanger in order to cool down said process gas flow.

In this version the process gas flow is cooled down to advantage successively in the condensate precooler, in the clean gas precooler, in the precooler and in the cryogenic cooler. The refrigerant consumption is clearly reduced in this manner. The sequence in which the process gas flow flows through the individual precoolers can also be changed if required.

Even in the precooler and/or in the clean gas cooler, if present, a part of the contaminations or substances present in the process gas are able to condense out. It is therefore favourable to likewise provide the precooler and/or the clean gas precooler with a condensate drain in order to be able to drain substances frozen-out from the process gas flow.

Advantageously the condensate obtained from the clean gas precooler and/or the precooler is likewise employed as refrigerant in the condensate precooler. However, it is also possible to provide separate heat exchangers in which the condensate from the precooler and/or the clean gas precooler is subjected to indirect heat exchange with the process gas flow.

The invention is of particular importance in petrochemical plants. Here, waste gas flows are frequently obtained which are subsequently supplied for combustion. Because of the increase of the raw material costs it is of particular interest to supply as little raw materials as possible for thermal reclamation but return them to the production process. These waste gas flows are therefore advantageously cleaned in the manner according to the invention wherein the raw materials contained in the waste gas are reclaimed as evaporated condensate.

A further advantage when using the invention in such plants is that gaseous nitrogen is required in most production plants. The nitrogen leaving the cryocondensation is not contaminated in any way and can be fed into existing nitrogen systems. This renders the method highly economical in two respects. In a concrete individual case, savings of liquid nitrogen in excess of 30% were calculated as a result.

During the further processing of ethylene purge flows are incurred which possess a high component of ethylene. The market price of ethylene is approximately 4 times the costs of the nitrogen required for the condensation according to the invention. Since the nitrogen can be reused the method is also highly attractive here.

The invention improves the economy of the existing cryocondensation methods significantly so that new applications, more preferably in the petrochemical industry can be exploited. Especially for larger volume flows the cryocondensation can be used in competition with other methods, more preferably adsorption and membrane methods.

The invention as well as additional details of the invention are explained in more detail in the following by means of the exemplary embodiments presented in the drawings. Here it shows:

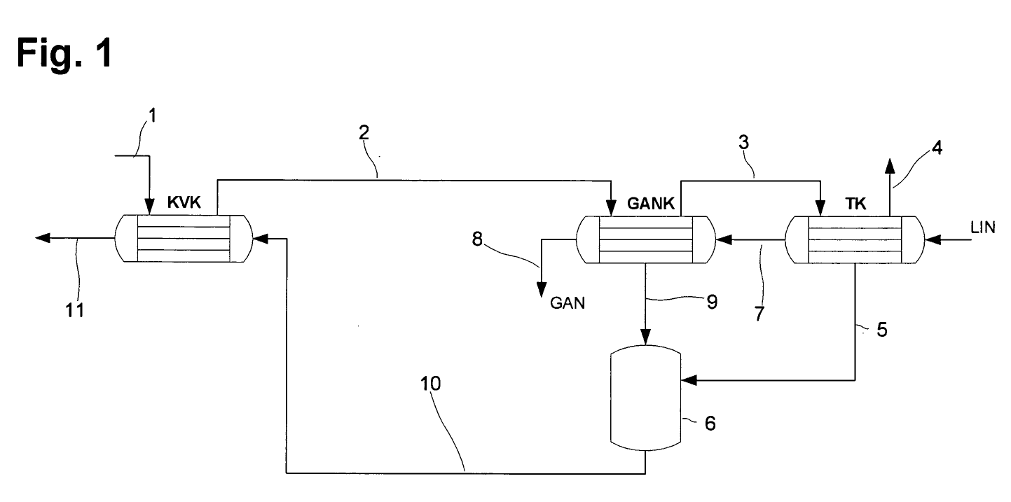

FIG. 1 a cryocondensation plant according to the invention and

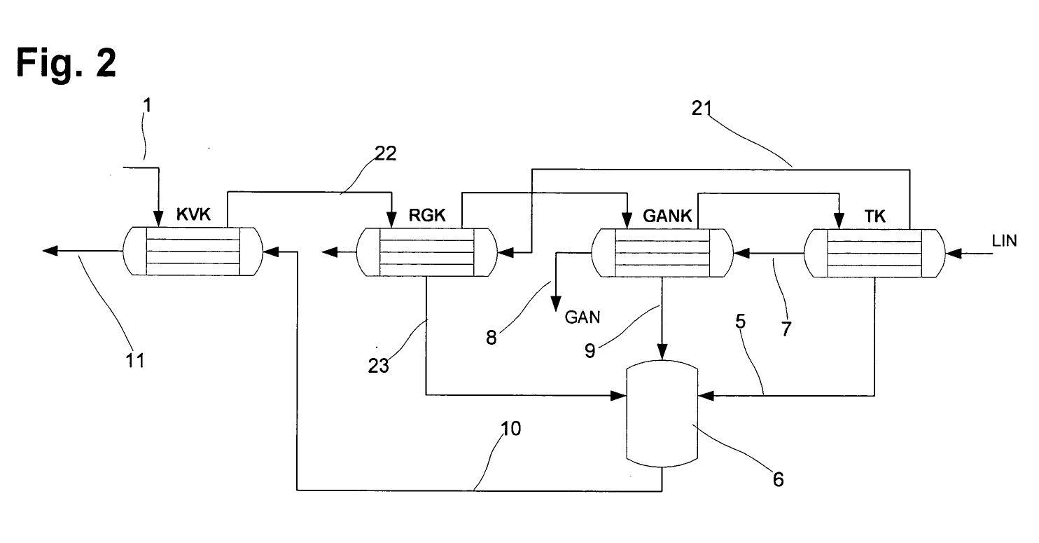

FIG. 2 an alternative embodiment of the plant according to the invention.

A cryocondensation plant according to the invention is schematically shown in FIG. 1. A process gas flow 1 is supplied to a precooler KVK hereinafter referred to as condensate precooler. The process gas flow 1 contains highly volatile or vaporous substances which are to be removed from the process gas flow. These substances can be contaminations or materials holding some value which are to be further processed. In the condensate precooler KVK the process gas flow 1 is cooled down and leaves the condensate precooler KVK with a lower temperature than precooled flow 2.

The precooled process gas flow 2 is subsequently further cooled down in a precooler GANK, hereinafter referred to as nitrogen precooler. The cold process gas flow 3 resulting from this is finally brought to the desired low target temperature in a cryogenic cooler TK. The process gas flow then leaves the cryogenic cooler TK as clean gas flow 4.

All heat exchangers, i.e. the condensate precooler KVK, the nitrogen precooler GANK and the cryogenic cooler TK are embodied as indirect heat exchangers, i.e. the heat exchangers have separate passages for the process gas flow to be cooled and the nitrogen employed as refrigerant or the cold condensate used as refrigerant.

Liquid nitrogen LIN is employed as refrigerant in the cryogenic cooler TK. The liquid nitrogen LIN flows through the cryogenic cooler against the flow direction of the process gas flow 3 cooling the latter down so far that all substances which are undesirable in the process gas flow 3 are liquefied. The resulting condensate is drained from the cryogenic cooler TK via a condensate drain 5 from the heat exchanger passages for the process gas flow 3 and supplied to a condensate vessel 6.

In the cryogenic cooler TK the liquid nitrogen is evaporated in the heat exchange with the process gas flow 3. The resulting gaseous nitrogen 7 is discharged into the nitrogen precooler GANK as refrigerant and, having left the nitrogen precooler GANK, is supplied for further utilisation, for example for inertisation.

Depending on the boiling point, a part of the substances present in the process gas flow 2 can also condensate out in the nitrogen precooler GANK. For this reason the nitrogen precooler GANK is also provided with a condensate drain 9 which discharges condensate that is created in the nitrogen precooler GANK into the condensate vessel 6.

The condensate 10 united in the condensate vessel 6 is discharged into the condensate precooler KVK and used as cold carrier. In the heat exchange with the warm process gas the condensate re-evaporates and, as gaseous valuable substance 11, can be further utilised or simply disposed of.

FIG. 2 shows an alternative embodiment of the invention with an additional clean gas precooler RGK which produces a further saving of nitrogen. The process gas flow 1 is directed into the condensate precooler KVK, the clean gas precooler RGK, the nitrogen precooler GANK and the cryogenic cooler TK one after the other. Cooling-down of the process gas in the condensate precooler KVK, the nitrogen precooler GANK and the cryogenic cooler TK takes place exactly as with the method according to FIG. 1.

In contrast with the method shown in FIG. 1 the cold of the clean gas 21 generated in the cryogenic cooler TK is also utilised for precooling the process gas 1. To this end, the cold clean gas 21 is conducted in the clean gas precooler RGK in counterflow to the process gas flow 22 leaving the condensate precooler KVK. The clean gas precooler RGK is also provided with a condensate drain 23 in order to drain and discharge condensate developing in the clean gas precooler RGK into the condensate vessel 6.

Here, precooling in the condensate precooler KVK can be set or controlled via the amount of condensate which is discharged from the condensate vessel 6 into the condensate precooler KVK.

1. A method for the cooling and/or cleaning of a process gas, wherein the process gas (1) in a cryogenic cooler (TK) is cooled and partially condensed in indirect heat exchange with a refrigerant flow (LIN) of nitrogen, wherein the contaminations are accumulated as condensate (5) and separated from the process gas flow (1, 2, 3), characterized in that the process gas (1) is precooled in a condensate precooler (KVK) in indirect heat exchange with the condensate (10) before being directed into the cryogenic cooler (TK).

2. The method according to claim 1, characterized in that the process gas (1), before being directed into the cryogenic cooler (TK), is precooled in a precooler (GANK) in indirect heat exchange with the refrigerant flow (7) leaving the cryogenic cooler (TK).

3. The method according to claim 1 and 2, characterized in that the process gas (1) is initially directed into the condensate precooler (KVK) and subsequently into the precooler (GANK).

4. The method according to any one of the claims 1 to 3, characterized in that the process gas (22) is precooled in a clean gas precooler (RGK) in indirect heat exchange with the process gas (21) leaving the cryogenic cooler (TK).

5. The method according to any one of the claims 1 to 4, characterized in that in the precooler (GANK) and/or in the clean gas precooler (RGK) condensate (9, 23) is separated from the process gas flow (22, 2) and supplied to the condensate precooler (KVK).

6. A method for the cooling and/or cleaning of a process gas, comprising a cryogenic cooler (TK) embodied as indirect heat exchanger with a process gas feed (3) and the process gas discharge (4), with a refrigerant feed (LIN) and a refrigerant discharge (7) and with a condensate drain (5), characterized in that a condensate precooler (KVK) embodied as indirect heat exchanger with a process gas feed (1) and a process gas discharge (2) and with a refrigerant feed (10) and a refrigerant discharge (11) is provided, wherein both the process gas discharge (2) of the condensate precooler (KVK) and the process gas feed (3) of the cryogenic cooler (TK) and also the condensate drain (5) of the cryogenic cooler (TK) and the refrigerant feed (10) of the condensate precooler (KVK) are connected on the flow side.

7. The device according to claim 6, characterized in that a precooler (GANK) embodied as indirect heat exchanger with a process gas feed (2), a process gas discharge (3), a refrigerant feed (7) and a refrigerant discharge (8) is provided, wherein the process gas discharge (3) of the precooler (GANK) are connected on the flow side with the process gas feed (3) of the cryogenic cooler (TK) and the refrigerant discharge (7) of the cryogenic cooler (TK) are connected on the flow side with the refrigerant feed (7) of the precooler (GANK).

8. The device according to claim 6 or 7, characterized in that a clean gas precooler (RGK) embodied as indirect heat exchanger with a process gas feed (22), a process gas discharge, a clean gas feed (22) and a clean gas discharge is provided, wherein the process gas discharge (21) of the cryogenic cooler (TK) is connected on the flow side with the clean gas feed (21) of the clean gas precooler (RGK) and the process gas discharge of the clean gas precooler (RGK) is connected on the flow side with the process gas feed of the cryogenic cooler (TK) and/or with the process gas feed of the precooler (GANK).

9. The device according to one of the claims 7 and/or 8, characterized in that the precooler (GANK) and/or the clean gas precooler (RGK) is provided with a condensate drain (9, 23) which on the flow side is connected with the refrigerant feed (10) of the condensate precooler (KVK).
